(19) United States
(12) Patent Application Publication
(10) Pub. No.: US 2013/0328950 A1
(43) Pub. Date: Dec. 12, 2013

(54) METHOD AND APPARATUS FOR REDUCING POWER CONSUMPTION FOR DISPLAYS

(71) Applicants: Maximino Vasquez, Fremont, CA (US); Achintya Bhowmik, Milpitas, CA (US); Yanli Zhang, San Jose, CA (US); Akihiro Takagi, San Mateo, CA (US)

(72) Inventors: Maximino Vasquez, Fremont, CA (US); Achintya Bhowmik, Milpitas, CA (US); Yanli Zhang, San Jose, CA (US); Akihiro Takagi, San Mateo, CA (US)

(21) Appl. No.: 13/965,095

(22) Filed: Aug. 12, 2013

Related U.S. Application Data
(63) Continuation of application No. 12/164,704, filed on Jun. 30, 2008.

(51) Int. Cl. G09G 5/04

(52) U.S. Cl. CPC G09G 5/04
USPC 345/690; 345/88

(57) ABSTRACT

A system, apparatus and method to reduce power consumption for displays is described. The method may include receiving image data comprising a plurality of color components, generating a histogram for each of the plurality of color components, and adjusting each of a plurality of light sources based on the histograms. The plurality of light sources may correspond to the plurality of color components. Other embodiments are described and claimed.

### CROSS-REFERENCE OF RELATED APPLICATIONS

This application is a continuation of, claims the benefit of and priority to, previously filed U.S. patent application Ser. No. 12/164,704 entitled “METHOD AND APPARATUS FOR REDUCING POWER CONSUMPTION FOR DISPLAYS” filed on Jun. 30, 2008, the subject matter of which is hereby incorporated by reference in its entirety.

### BACKGROUND

A computing system may include a processor, a chipset and a display having a plurality of light sources, each of which consume power in the system. As computing systems continue to become more mobile, power conservation in the devices becomes an increasingly important consideration. Continual operation of color displays in computing systems results in an increase in power consumption. Consequently, there exists a substantial need for techniques to improve the power consumption for displays.

### BRIEF DESCRIPTION OF THE DRAWINGS

FIG. 1 illustrates one embodiment of an apparatus.

FIG. 2A illustrates one embodiment of a pixel.

FIG. 2B illustrates one embodiment of a pixel.

FIG. 3 illustrates one embodiment of a logic flow.

FIG. 4 illustrates one embodiment of a logic flow.

### DETAILED DESCRIPTION

Liquid crystal displays (LCD) are often the highest power consuming component of a mobile computer. For example, in some embodiments, a display of a notebook computer may consume 30-40% of the total platform average power over time. As a result, to increase performance and battery life of mobile computing systems, a substantial need exists to reduce display power consumption.

Various embodiments may be generally directed to a method and apparatus for reducing power consumption for displays. In one embodiment, for example, image data comprising a plurality of color components may be received and a histogram for each of the plurality of color components may be generated. Each of a plurality of light sources may be adjusted based on the histograms where the plurality of light sources correspond to the plurality of color components. In this manner, the power supplied to each light source may be adjusted to conserve power for the system. Other embodiments are described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

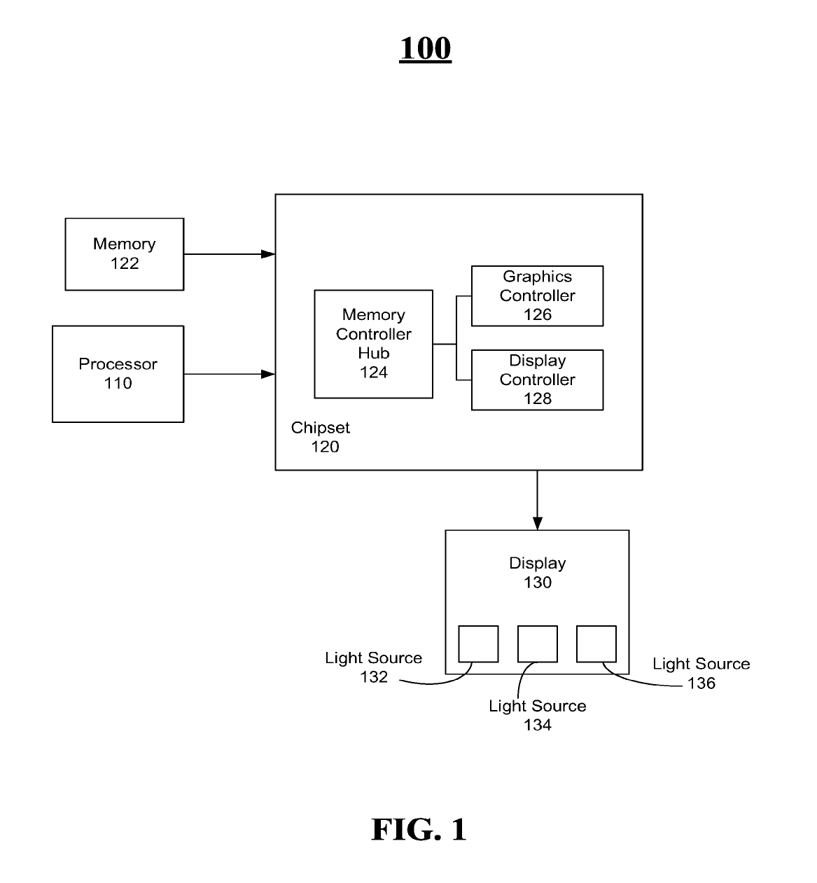

FIG. 1 illustrates a computing system 100 in accordance with one or more embodiments. In general, the computing system 100 may comprise various physical and/or logical components for communicating information which may be implemented as hardware components (e.g., computing devices, processors, logic devices), executable computer program instructions (e.g., firmware, software) to be executed by various hardware components, or any combination thereof, as desired for a given set of design parameters or performance constraints. Although FIG. 1 may show a limited number of components by way of example, it can be appreciated that a greater or a fewer number of components may be employed for a given implementation.

In various embodiments, the computing system 100 may be implemented by a computing platform such as a mobile platform, personal computer (PC) platform, and/or consumer electronics (CE) platform supporting various networking, communications, and/or multimedia capabilities. Such capabilities may be supported by various networks, such as a Wide Area Network (WAN), Local Area Network (LAN), Metropolitan Area Network (MAN), wireless WAN (WWAN), wireless LAN (WLAN), wireless MAN (WMAN), wireless personal area network (WPAN), Worldwide Interoperability for Microwave Access (WiMAX) network, broadband wireless access (BWA) network, the Internet, the World Wide Web, telephone network, radio network, television network, cable network, satellite network such as a direct broadcast satellite (DBS) network, Code Division Multiple Access (CDMA) network, third generation (3G) network such as Wide-band CDMA (WCDMA), fourth generation (4G) network, Time Division Multiple Access (TDMA) network, Extended-TDMA (E-TDMA) cellular radiotelephone network, Global System for Mobile Communications (GSM) network, GSM with General Packet Radio Service (GPRS) systems (GSM/GPRS) network, Synchronous Division Multiple Access (SDMA) network, Time Division Synchronous CDMA (TD-SCDMA) network, Orthogonal Frequency Division Multiplexing (OFDM) network, Orthogonal Frequency Division Multiple Access (OFDMA) network, North American Digital Cellular (NADC) cellular radiotelephone network, Narrowband Advanced Mobile Phone Service (NAMPS) network, Universal Mobile Telephone System (UMTS) network, and/or any other wired or wireless network in accordance with the described embodiments.

In some implementations, the computing system 100 may comprise a system within and/or connected to a computing device such as PC, desktop PC, notebook PC, laptop computer, mobile computing device, smart phone, personal digital assistant (PDA), mobile telephone, combination mobile telephone/PDA, video device, television (TV) device, digital TV (DTV) device, high-definition TV (HDTV) device, media player device, gaming device, or other type of computing device in accordance with the described embodiments.

The computing system 100 may form part of a wired communications system, a wireless communications system, or a combination of both. For example, the computing device may be arranged to communicate information over one or more types of wired communication links. Examples of a wired communication link, may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The computing system may be arranged to communicate information over one or more types of wireless communication links. Examples of a wireless communication link may include, without limitation, a radio channel, satellite channel, television channel, broadcast channel infrared channel, radio-frequency (RF) channel, Wireless Fidelity (WiFi) channel, a portion of the RF spectrum, and/or one or more licensed or license-free frequency bands. In wireless implementations, the mobile computing device may comprise one or more interfaces and/or components for wireless communication such as one or more transmitters, receivers, transceivers, amplifiers, filters, control logic, wireless network interface cards (WNICs), antennas, and so forth. Although certain embodiments may be illustrated using a particular communications media by way of example, it may be appreciated that the principles and techniques discussed herein may be implemented using various communication media and accompanying technology.

FIG. 1 depicts a computing system 100 for processing and displaying graphics in some embodiments. In various embodiments, computing system 100 may comprise a processor 110, chipset 120, memory 122 and display 130. Processor 110 may comprise any suitable general purpose or dedicated processor, such as an Intel® Centrino® processor made by Intel Corporation® of Santa Clara, Calif., for example.

Chipset 120 may comprise memory controller hub (MCH) 124, graphics controller 126 and display controller 128 in some embodiments. While some embodiments describe functions being executed by either the graphics controller 126 or the display controller 128, it should be understood that the described functionality could be executed by the graphics controller 126, the display controller 128 or any other suitable controller in some embodiments. In various embodiments, the chipset 120 may comprise an embedded processing device on a chipset implemented by a computing platform and/or computing device.

The chipset 120 may be mounted to a circuit board (e.g., motherboard, baseboard, system board, logic board, etc.) that comprises or supports various system components and features in addition to the chipset such as a central processing unit (CPU), a basic I/O system (BIOS), memory (e.g., volatile or non-volatile memory, removable or non-removable memory, erasable or non-erasable memory, writeable or re-writeable memory) such as double-data-rate two synchronous dynamic random access memory (DDR2) and flash memory, a network interface card (NIC) (e.g., Ethernet LAN adapter, WNIC), controllers such as an embedded controller (EC), system management controller (SMC), keyboard controller (KBC), and/or LAN controller, a clock such as a real-time clock (RTC), as well as other components and features in accordance with the described embodiments.

The circuit board also may comprise or support various interfaces and connectors such as video graphics array (VGA), low-voltage differential signaling (LVDS), TV-out (e.g., D-connector, S-Video, component video, composite video), serial digital video out (SDVO), peripheral component interconnect (PCI), PCI Express, on-board LAN, serial peripheral interface (SPI), Advanced Technology Attachment (ATA), Universal Serial Bus (USB), Low Pin Count (LPC), Infrared Data Association (IrDA), universal asynchronous receiver/transmitter (UART), system management bus (SMBus), and other interfaces and connectors in accordance with the described embodiments.

MCH 124 may comprise a controller for allowing a processor to access memory, for example. The processor 110 determines what data is to be displayed on display 130 in some embodiments. In various embodiments, the data to be displayed is accessed from memory 122 by MCH 124 and displayed on display 130.

Memory 122 may contain a description of a memory buffer in one area and a buffer containing image data in another area, for example. In some embodiments, data is stored in memory 122 in packet format. The embodiments are not limited in this context. When stored in packet format, the packet comprises a header portion and a payload portion. The header provides the position and dimension of the image to be displayed. The payload contains the data of the image to be displayed. Thus, the packet graphics files must be rasterized or reconstructed out of those components before they can be presented as an actual image on the display 130. The graphics controller 126 computes and creates a bitmap of the data accessed by the MCH 124. The bitmapped file contains pixel image data which is written to memory by the MCH 124. Each dot or pixel on the display 130 is represented by data in the bitmapped file. The display controller 128 reads the bitmapped file from memory using the MCH 124, and sends the data stream of pixels to the display 130 to be displayed. Other embodiments are described and claimed.

In various embodiments, display 130 may comprise light sources 132, 134 and 136. While shown with a limited number of light sources, it should be understood that any number of light sources could be implemented in display 130 and still fall within the described embodiments. The light sources 132, 134 and 136 may comprise any backlight suitable for illuminating a display. For example, light sources 132, 134 and 136 may comprise time-sequentially lit RBG backlights. In some embodiments, light sources 132, 134 and 136 may be implemented in a high-color-gamut display as separate red, green and blue light sources.

Display 130 may comprise any type of display suitable for displaying visual or graphical representations of image data. For example, in some embodiments, display 130 may comprise a liquid crystal display (LCD). In various embodiments display 130 may implement red, green and blue (RGB) sub-pixels for every pixel in the display. In various embodiments, the display 130 may implement any set of color components and still fall within the described embodiments. For example, display 130 may implement RGB, RGBW or RGBMY in some embodiments. In some embodiments, display 130 may implement separate colored light sources, such as red, green and blue light sources, for example. While a limited number of light sources are described in various embodiments, it should be understood that any number of light sources could be used and still fall within the described embodiments.

While a limited number of elements are shown in FIG. 1, it should be understood that any number or combination of elements could be combined and still fall within the described embodiments. For example, in some embodiments the graphics controller 126 and the display controller 128 may be located on a discrete graphics chip rather than on chipset 120. Additionally, in various embodiments, display 130 may include logic such as a receiver, timing controller and buffer, for example. Other embodiments are described and claimed.

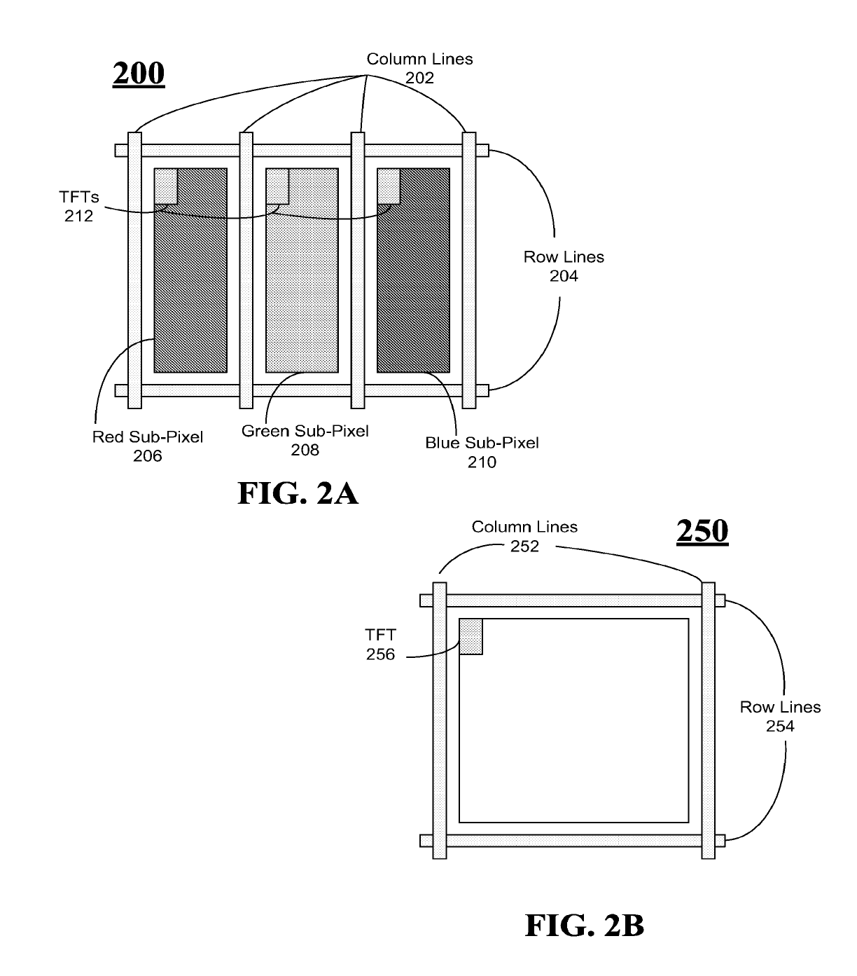

FIG. 2A illustrates one embodiment of a pixel 200 of a display. For example, pixel 200 may comprise one of many pixels contained in display 130. Pixel 200 may represent a pixel in a display that contains a single light source or a plurality of light sources. Pixel 200 comprises column lines 202, row lines 204, red sub-pixel 206, green sub-pixel 208, blue sub-pixel 210 and thin film transistors (TFTs) 212. Pixel 200 may be implemented as part of a spatial generation color scheme, for example. In a spatial generation color scheme, a side-by-side matrix of three sub-pixels covered with a plurality of color filters, such as red (206), green (208) and blue (210) color filters for example, are transmission-modulated to create an image. One potential drawback of this type of mechanism is that up to 70% of light being generating by the light source may be lost and the brightness of the display may be limited due to absorption in the color filters and blocking areas occupied by the TFTs 212 and row 204 and column 202 lines for every sub-pixel. This loss of light results in high power consumption by the display.

FIG. 2B illustrates one embodiment of a pixel 250 of a display. Pixel 250 comprises column lines 252, row lines 254 and TFT 256. In some embodiments, pixel 250 may comprise one of many pixels contained in display 130 implementing a field-sequential color (FSC) architecture.

In various embodiments, the FSC architectures does not require separate color component sub-pixels as described above with reference to FIG. 2A. The FSC architecture uses approximately one-third of the light blocking elements such as TFTs and row and column lines as compared to pixel 200, for example. As a result, less light is absorbed and the light sources used in conjunction with the FSC architecture may be operated more efficiently.

Returning to FIG. 1, in various embodiments, the display controller 128 may be operative to independently adjust or control each of the plurality of light sources (132, 134 and 136) for display 130 based on a distribution of color components in image data received from the memory 122. In some embodiments, histograms are generated by the display controller 128 for each of the plurality of color components and the histograms are based on the distribution of color components. For example, the display controller 128 may generate separate histograms for each of the red, green and blue color components in the image data.

In various embodiments, the histograms for each of the red, green and blue color components of the image data are used to calculate the power reduction for each of the red, green and blue light sources, for example. Each histogram comprises a distribution of the values of the particular color component. Based on the distribution, it is possible to determine, for example, if pixel values for a particular color component are low and can be increased, allowing for a reduction in the intensity of the associated light source.

In various embodiments, the intensity of pixel values can be adjusted to allow for adjustments of the light sources. For example, if image data contains low pixel values for a certain color, the pixels for that color can be intensified and the intensity of the corresponding light source for that color can be reduced. In this manner, the power consumed by the light source can also be reduced.

In some embodiments, the display controller 128 may adjust the intensity of pixels for each of the plurality of color components in proportion to the adjustment of each of the plurality of light sources. For example, display controller 128 may increase the intensity of red, green or blue pixels in the image data if the intensity of the corresponding red, green or blue light sources is decreased or decrease the intensity of the red, green or blue pixels in the image data if the intensity of the corresponding red, green or blue light sources is increased. The proportional changes to the pixel intensity and the intensity of the light sources are selected to be approximately visually equivalent. Other embodiments are described and claimed.

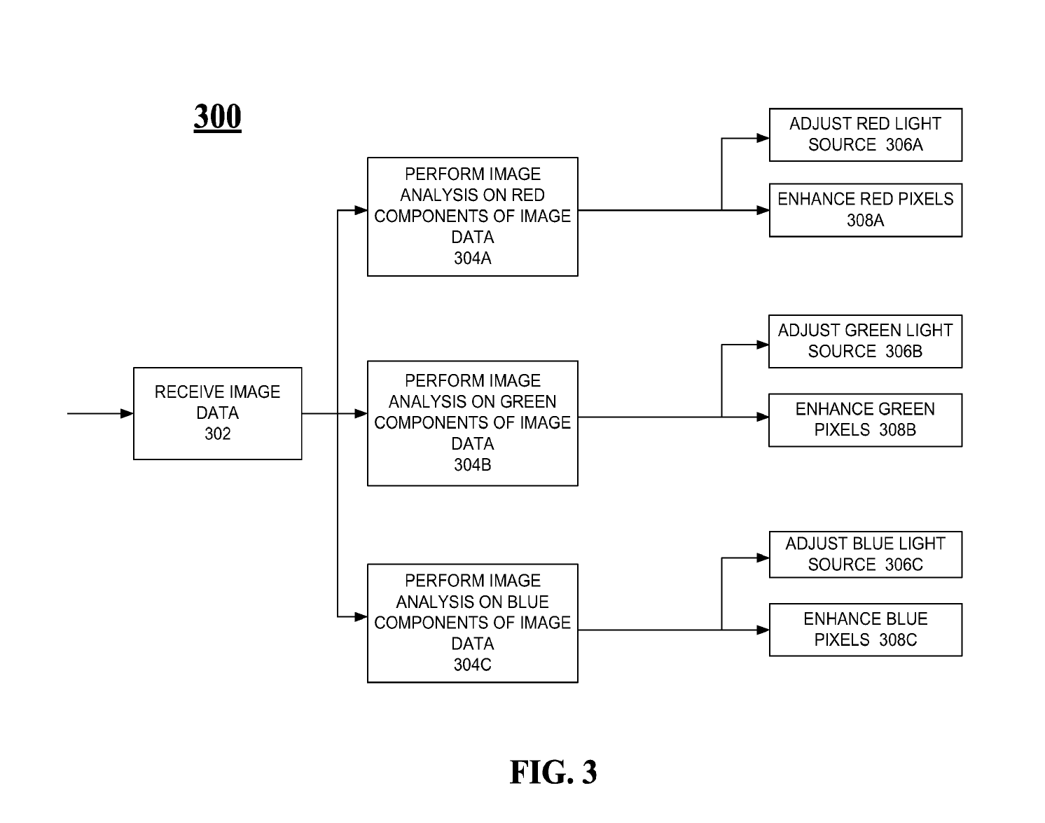

FIG. 3 illustrates one embodiment of a logic flow 300 in accordance with one or more embodiments. The logic flow 300 may be performed by various systems and/or devices and may be implemented by one or more logic devices (e.g., processor, hardware components) and/or logic comprising executable computer program instructions (e.g., firmware, software) to be executed by a logic device.

The logic flow 300 may comprise receiving image data at 302. For example, image data from memory 122 may be retrieved by display controller 126. In various embodiments, image analysis may be performed on the red components of the image data at 304A, on the green components at 304B and on the blue components at 304C. In some embodiments, the image data is broken into respective red, green and blue components and image analysis may be performed on each of the components of the image data. For example, the image analysis may comprise generating a histogram for each color component and using the histogram and an algorithm to determine an amount that each pixel of an image can be adjusted.

In some embodiments, the algorithm may be configured to determine intensity for each pixel and calculate an amount of possible adjustment for each pixel. For example, the algorithm may determine that the intensity for certain pixels can be increased by a certain amount. If so, the pixels may be adjusted accordingly. At 308A the red pixels are enhanced, at 308B the green pixels are enhanced and at 308C the blue pixels are enhanced.

In various embodiments, the red light source may be adjusted at 306A, the green light source may be adjusted at 306B and the blue light source may be adjusted at 306C. It should be understood that any number of light sources could be used and still fall within the described embodiments. If, based on the image analysis performed on the red components of the image data at 304A, it is determined that certain red pixels can be enhanced, the intensity of the red light source may be reduced, for example. The enhancement of the pixels and adjustment of the light source should be selected to be approximately visually equivalent such that the image does not appear differently on the display as perceived by a user. While shown with a limited number of steps, it can be appreciated that the logic flow 300 may comprise various other steps in accordance with the described embodiments.

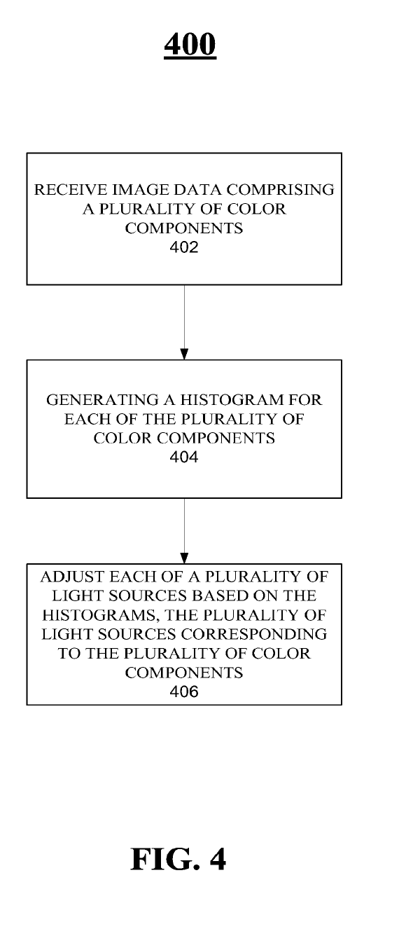

FIG. 4 illustrates a logic flow 400 in accordance with one or more embodiments. The logic flow 400 may be performed by various systems and/or devices and may be implemented by one or more logic devices (e.g., processor, hardware components) and/or logic comprising executable computer program instructions (e.g., firmware, software) to be executed by a logic device.

The logic flow 400 may comprise receiving image data comprising a plurality of color components at 402. For example, display controller 128 may retrieve image data from memory 122 in some embodiments. At 404, a histogram is generated for each of the plurality of color components. In some embodiments, the plurality of color components comprise red, green and blue color components for the image data and a histogram is generated for each of the red, green and blue color components. Each of a plurality of light sources may be adjusted based on the histograms at 406. In various embodiments, the plurality of light sources correspond to the plurality of color components. For example, the plurality of light sources may comprise separate red, green and blue backlights for a liquid crystal display (LCD).

In various embodiments, each of the plurality of color components of the image data may be adjusted in proportion to the adjusting of each of the plurality of light sources. For example, the color components or pixel intensity values may be increased in an approximately visually equivalent amount to the amount of reduction in intensity of the light sources. In some embodiments, if the intensity of red, green or blue pixels in the image data is increased, the intensity of corresponding red, green or blue light sources is decreased and if the intensity of the red, green or blue pixels in the image data is decreased, the intensity of the corresponding red, green or blue light sources is increased. In this manner, the adjusting of the plurality of light sources may comprise reducing an amount of power provided to a light source. By reducing the amount of power provided to a light source, the power consumed by the display may be reduced. It can be appreciated that the logic flow 400 may include various other steps in accordance with the described embodiments.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

Although some embodiments may be illustrated and described as comprising exemplary functional components or modules performing various operations, it can be appreciated that such components or modules may be implemented by one or more hardware components, software components, and/or combination thereof.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated.

In various embodiments, the logic flow may comprise, or be implemented as, executable computer program instructions. The executable computer program instructions may be implemented by firmware, software, a module, an application, a program, a subroutine, instructions, an instruction set, computing code, words, values, symbols or combination thereof. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computing device to perform a certain function. The executable computer program instructions may be implemented using any suitable programming language in accordance with the described embodiments.

In various embodiments, logic flow may comprise, or be implemented as, executable computer program instructions stored in an article of manufacture and/or computer-readable storage medium implemented by various systems and/or devices in accordance with the described embodiments. The article and/or computer-readable storage medium may store executable computer program instructions that, when executed by a computing device, cause the computing device to perform methods and/or operations in accordance with the described embodiments.

The article and/or computer-readable storage medium may comprise one or more types of computer-readable storage media capable of storing data, including volatile memory or, non-volatile memory, removable or non-removable memory, erasable or non-erasable memory, writeable or re-writeable memory, and so forth. Examples of computer-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other suitable type of computer-readable media in accordance with the described embodiments.

Unless specifically stated otherwise, it may be appreciated that terms such as “processing,” “computing,” “calculating,” “determining,” “deciding,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, API, exchanging messages, and so forth.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1-20. (canceled)

21. A method comprising:
receiving image data comprising multiple data portions, each data portion representing a different part of an image for a display device;
generating a histogram for each data portion, each histogram representing a distribution of values; and
adjusting a plurality of light sources based on the histograms, each of the plurality of light sources corresponding to a different data portion.

22. The method of claim 21, wherein each data portion corresponds to a different color component.

23. The method of claim 22, wherein the different color components comprise red, green, and blue.

24. The method of claim 21, wherein the display device comprises a liquid crystal display.

25. A computer-readable storage medium storing instructions that, when executed by a computer device, cause performance of the following operations:
receiving image data comprising multiple data portions, each data portion representing a different part of an image for a display device;
generating a histogram for each data portion, each histogram representing a distribution of values; and
adjusting a plurality of light sources based on the histograms, each of the plurality of light sources corresponding to a different data portion.

26. The medium of claim 25, wherein each data portion corresponds to a different color component.

27. The medium of claim 26, wherein the different color components comprise red, green, and blue.

28. The medium of claim 25, wherein the display device comprises a liquid crystal display.

29. An apparatus comprising:
a display device and a processor, apparatus configured to
receive image data comprising multiple data portions, each data portion representing a different part of an image for a display device;
generate a histogram for each data portion, each histogram representing a distribution of values; and
adjust a plurality of light sources based on the histograms, each of the plurality of light sources corresponding to a different data portion.

30. The apparatus of claim 29, wherein each data portion corresponds to a different color component.

31. The apparatus of claim 30, wherein the different color components comprise red, green, and blue.

32. The apparatus of claim 29, wherein the display device comprises a liquid crystal display.

33. A system comprising:
a processor, a memory, a graphics controller, a keyboard controller, and a display device having display elements in multiple colors and lighting sources to illuminate the display elements, wherein the processor, memory, graphics controller, and display device are configured to:
receive image data comprising multiple data portions, each data portion representing a different part of an image for a display device;
generate a histogram for each data portion, each histogram representing a distribution of values; and
adjust a plurality of light sources based on the histograms, each of the plurality of light sources corresponding to a different data portion.

34. The system of claim 33, wherein each data portion corresponds to a different color component.

35. The system of claim 34, wherein the different color components comprise red, green, and blue.

36. The system of claim 33, wherein the display device comprises a liquid crystal display.
